(19) United States
(12) Patent Application Publication
(10) Pub. No.: US 2009/0289500 A1
(43) Pub. Date: Nov. 26, 2009

(54) ENERGY SUPPLY DEVICE FOR A PLURALITY OF ENERGY CONSUMERS CONNECTED THERETO

(75) Inventors: Jürgen Zipp, Braunfels (DE); Thomas Kammer, Biebertal (DE); Steffen Medebach, Wetzlar (DE)

Correspondence Address: CONNOLLY BOVE LODGE & HUTZ, LLP, P O BOX 2207, WILMINGTON, DE, 19899, US

(73) Assignees: KUSTER AUTOMOTIVE DOOR SYSTEMS GMBH, Wetzlar (DE); GRASS GMBH, Hoechst (AT)

(21) Appl. No.: 12/295,638

(22) PCT Filed: Apr. 3, 2007
(86) PCT No.: PCT/EP2007/002971

§ 371 Date: Dec. 17, 2008

(30) Foreign Application Priority Data
Apr. 4, 2006 (DE) 10 2006 016 080.0

(51) Int. Cl. H02J 3/00

(52) U.S. Cl. 307/31

(57) ABSTRACT

An energy supply device (10) for a plurality of energy consumers (3) connected thereto has a predetermined maximum power output. A monitoring device for the output of power prevents the maximum output of power of the energy supply device (10) from being exceeded.

### CROSS-REFERENCE TO RELATED APPLICATION

This application is a national stage application (under 35 U.S.C. § 371) of PCT/EP2007/002971, filed Apr. 3, 2007, which claims benefit of German application 10 2006 016 080.0, filed Apr. 4, 2006.

### DESCRIPTION

The invention relates to an energy supply device, which is intended for a plurality of energy consumers, which are to be connected to said energy supply device, and which exhibits a predetermined maximum power output.

### BACKGROUND ART

Such energy supply devices having a maximum power output exist in a variety of designs. In particular, the DE 699 06 299 T2 discloses a device for controlling a plurality of drawers. With this device a plurality of drawers can be moved in a furniture body by means of an energy supply device.

Since each energy supply device exhibits a maximum power output, it is necessary during the design stage to dimension the energy supply device as a function of the consumers that are to be attached. If at a later date additional energy consumers are to be connected to the energy supply device, then there is the risk that in service the maximum power output will be exceeded. The result may be damage to the energy supply device, if a plurality of consumers have to be supplied with energy at the same time.

Disclosed in the US 2004/0075343 A1 is a device and a method for controlling the output power of an energy source with a control unit, which controls the load control switches, were are inserted between a distributor panel and the energy supply units, as a function of the capacity of the energy source and the power consumption.

The US 2003/0151309 A1 discloses a device for distributing the energy in an overload situation of an airport support system, which takes over the energy distribution on the basis of a known maximum output power of a line as a function of the state, for example, of a connecting bridge to an airplane, in order not to overload the line.

### SUMMARY OF THE INVENTION

Therefore, the object of the invention is to improve an energy supply device in such a way that without modifying the energy supply device maximum flexibility is provided with respect to the objects that are to be supplied.

Owing to the provision of a monitoring device, which is provided for the output power of the energy supply device and which prevents the energy supply device from exceeding the maximum output power, it is guaranteed that an overload operation of the energy supply device cannot take place. This measure is an effective way to prevent damage to the energy supply device due to overloading.

Furthermore, it is provided that the energy supply device is designed for the subsequent attachment of additional consumers. Owing to this measure it is possible to attach additional energy consumers into an existing system, for example in a building system or in a piece of furniture comprising several energy consumers without having to install an additional energy supply device in parallel to the existing energy supply device.

The inventive energy supply devices can be installed, for example, in modular furniture or also in building systems. Such furniture or building systems can also be provided with additional energy consumers upon completion without exceeding the maximum power output when the energy supply device is running.

According to a first advantageous embodiment of the invention, the energy supply device is an electric power supply device. Such an electric power supply device is an option as an energy supply device because today almost all energy consumers in building systems and/or private households or even furniture are operated with electric energy.

Furthermore, it is provided that the energy supply device is designed for the subsequent attachment of additional consumers. Owing to this measure it is possible to attach additional energy consumers into an existing system, for example in a building system or in a piece of furniture comprising several energy consumers without having to install an additional energy supply device in parallel to the existing energy supply device.

An especially advantageous embodiment of the invention provides that the monitoring device is designed to stop the switching on of a consumer, if by switching on, the maximum power output and/or a predefined limit value for the power output would be exceeded. This measure guarantees a reliable overload protection for the energy supply device. The energy supply device will not deliver more energy at any time than the maximum power output and/or than the predefined limit value for the power output.

According to another advantageous embodiment of the invention, the energy consumers, which are to be connected to the energy supply device, are assigned a priority. In this case the monitoring device is designed for switching off at least one energy consumer having a low priority, if by switching on an additional energy consumer the maximum power output and/or a predefined limit value for the power output would be exceeded. This measure guarantees that the energy consumers, which rely on the continuous supply of energy, are given a high priority and, for this reason, are not switched off at any time when a consumer with a lower priority is switched on. Inversely consumers with a low priority are switched off, when an additional consumer with a higher priority is switched on.

It is advantageously provided that upon switching off the additional energy consumer, which was previously switched on, the monitoring device is designed for switching on the at least one energy consumer, which was previously switched off. This measure restores the same state that prevailed in the system before the additional energy consumer was switched on.

Another embodiment of the invention provides a microcontroller control unit, which comprises the monitoring device for checking and controlling the power output to the attached consumers. Such a microcontroller control unit allows the monitoring device to be integrated in the energy supply device. Furthermore, it has been possible in the meantime to produce such microcontroller control units as a mass production item at an economical cost, and with suitable programming they can be optimally adapted to existing systems.

In this case it has proven to be advantageous to connect the microcontroller control unit to all of the attached consumers by way of a data bus. Such a data bus allows a simple communication between the microcontroller control unit and the attached consumers. In this respect it is also advantageous that such data buses are already integrated into many systems, for example building systems or furniture, and do not have to be installed separately. To this end, a simple connection to the already existing bus system is totally adequate.

Furthermore, it has turned out to be advantageous to design the microcontroller control unit as a master unit and to design the attached consumers as the slave unit of a master/slave configuration. This configuration guarantees that, as the master unit, the microcontroller control unit drives the attached consumers, and they in turn process the tasks that are assigned to them. Therefore, the microcontroller control unit no longer has to deal with the individual tasks that are to be performed by the attached consumers, but rather merely instructs the consumers, as the slave unit, to perform these tasks independently.

According to an additional embodiment of the invention, the monitoring device is designed for switching off all of the attached consumers, if an overload of the energy supply device, for example, as a consequence of a short circuit, is detected. This measure achieves the goal that no additional damage to the whole system will occur, because upon switching off all of the attached consumers, there is no longer any energy consumption.

Furthermore, it can be provided that the monitoring device and/or the microcontroller control unit is/are provided with an activatable and deactivatable energy saving device, by means of which the attached consumers are put into a state of minimum energy consumption. This measure makes it possible to immediately activate the attached consumers in situations of minimum energy consumption, when the energy saving device is in the activated mode.

In this case it has proven to be advantageous to provide the monitoring device and/or the microcontroller control unit with a time limit switch, by means of which the energy saving device can be activated and deactivated. This measure makes it possible to minimize the energy consumption of the whole system, in that the energy saving device is activated by the time limit switch, when over a predefined period of time the energy output has dropped below a certain limit value.

Furthermore, it has proven to be advantageous to provide the monitoring device and/or the microcontroller control unit with a temperature measuring device, by means of which the energy output to the attached consumers is throttled or rather switched off upon exceeding an internal threshold temperature. This measure guarantees that the whole system and/or the individual end consumers are not damaged by overheating.

An additional idea of the invention provides that an interface for attaching to an already existing network, in particular a home appliance network, is provided preferably with a CHAIN bus. This measure makes it possible to connect the inventive energy supply device to an already existing system, so that there is no need for additional installation work.

An independent idea of the invention provides a bus system, which exhibits at least one power bus for connecting a plurality of energy consumers to an energy supply device and exhibits at least one data bus, which is used to communicate between a control unit and the attached energy consumers, in order to check and to control the power output of the energy supply device to the energy consumers. This measure satisfies the requirement that the output power of the energy supply device can be monitored quickly and by simple technical means, in order to prevent, for example, the energy supply device from being damaged by overloading.

In this case it can be provided that the bus system exhibits an interface for attachment to an already existing network, in particular a home appliance network, preferably with a CHAIN bus. This measure makes it possible to couple the bus system to an existing network system without incurring high installation costs.

Furthermore, it has been proven to be advantageous to provide a furniture article and/or a building system or a building with at least one above-described inventive energy supply device and optionally an inventive bus system.

An additional idea of the invention provides the application of a bus system for use of a plurality of energy consumers, preferably a furniture article or a building system, at an energy supply device as well as for checking and controlling the power output to the energy consumers.

### BRIEF DESCRIPTION OF THE DRAWINGS

Other goals, advantageous features, and possible applications of the present invention are disclosed in the following description of the embodiments with reference to the drawings. In this case all of the described and/or depicted features form by themselves independently or in any logical combination the subject matter of the present invention, even independently of their summary in the claims or their references.

FIG. 1 depicts a furniture article comprising four drawers and one embodiment of an inventive energy supply device.

FIG. 2 depicts a furniture article comprising four drawers and an additional embodiment of an inventive energy supply device.

FIG. 3 depicts an additional furniture article comprising four drawers and an additional embodiment of an inventive energy supply device, and

FIG. 4 depicts a furniture article comprising four drawers and an additional embodiment of an inventive energy supply device.

### DETAILED DESCRIPTION OF THE INVENTION

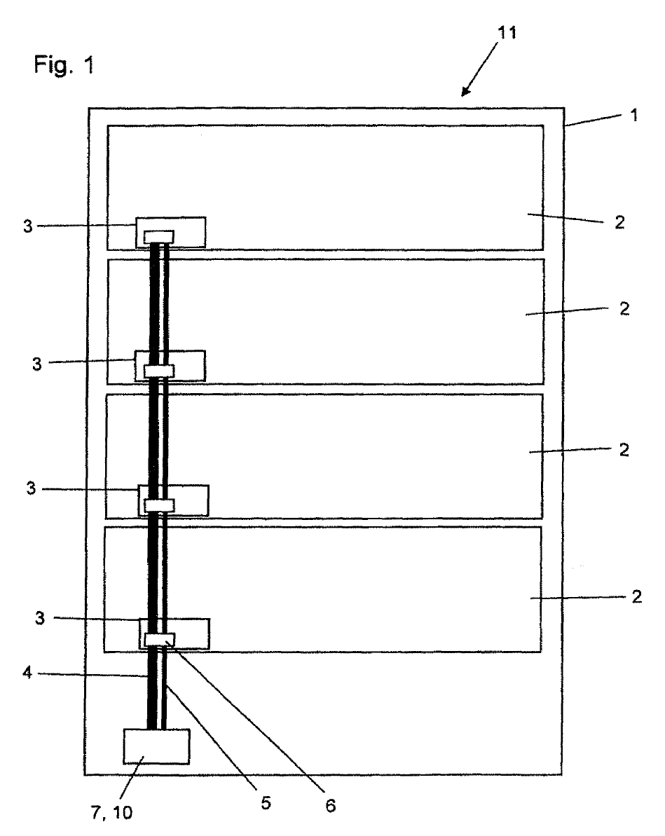

FIG. 1 depicts a furniture article 11 comprising four drawers 2, which are mounted in a displaceable manner in the furniture body 1. Each drawer 2 is provided with a drive 3. The drives 3 are connected together by a power bus 4 and by a data bus 6 and are connected to a control unit 7 of the power supply 10, which serves as the energy supply device. In this case the data bus 6 and the power bus 4 form preferably a bus system for the furniture article 11.

In the embodiment, according to FIG. 1, the power bus 4 and the data bus 5 are connected to the drives 3 of the drawers 2 by means of a common plug and socket connector 6. In this case the power supply 10 is designed as a direct current low voltage power supply having 24 volts. In addition to the consumers in the form of the drives 3, it is possible to attach additional consumers.

For example, they may be illuminating devices (not illustrated in this drawing) for the drawers or also warming plates in the drawers. If at this point one proceeds on the basis of an output power of 750 watts in the direct current low voltage power supply and assumes that the illumination of some of the open drawers needs 200 watts and a warming plate in another drawer needs 500 watts, then a reserve of 50 watts is left for the other consumers. If at this point another drawer is to be opened, for which a power of 100 watts is required, then the maximum output power of 750 watts would be exceeded by 50 watts. Thus, the power supply would be overloaded. In order to ensure that this does not happen, the control unit 7 is provided with a monitoring unit for the output power. In such a case the monitoring unit can decide, for example, that the drawer may not be opened, but can also make sure that, for example, the warming plate is switched off for a short period of time, so that once more adequate power is available for opening the additional drawer. Since the opening of the drawer does not take longer than 2 seconds, the warming plate can be switched on again, after the drawer is opened, so that the warming plate does not significantly cool down in this short period of time.

In order to enable the monitoring unit to make such decisions, the individual consumers, for example, the drives 3 and the warming plates, are provided with different priorities. Then the monitoring unit decides by means of the priority, which consumers can be switched off for either a short period of time or completely.

All of the attached consumers are encoded via the bus system by executing, preferably automatically, an installation routine, which is started, for example, upon the occurrence of a malfunction or deactivation of the system. Only thereafter is it possible to properly activate the individual consumers.

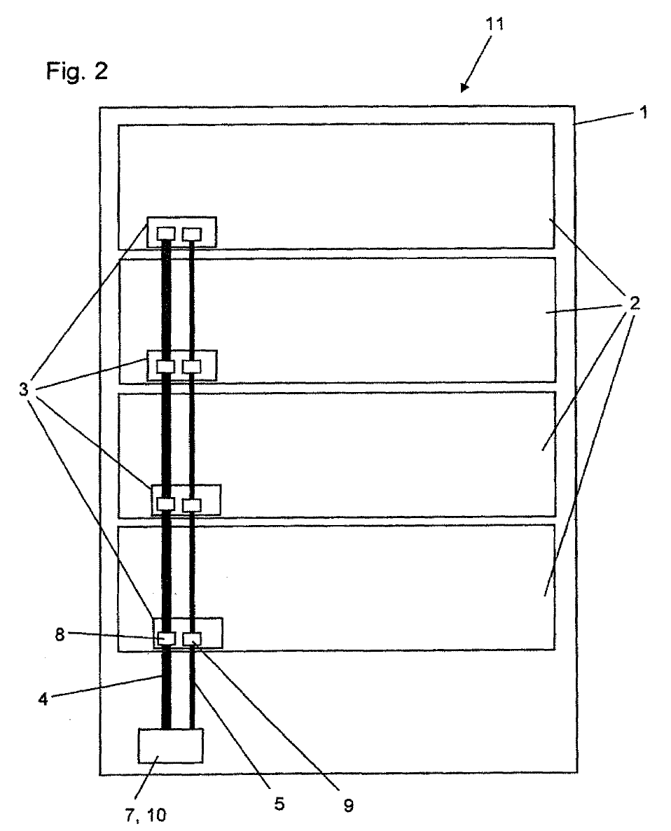

Another embodiment of the invention is shown in FIG. 2. The distinction between this embodiment and the one depicted in FIG. 1 lies in the separate plug and socket connectors 8, 9 for the power bus 4 and the data bus 5 in order to connect to the drives 3 and/or other consumers. The operating principle of the device depicted in FIG. 2 matches that of the device depicted in FIG. 1. This latter device has already been described above.

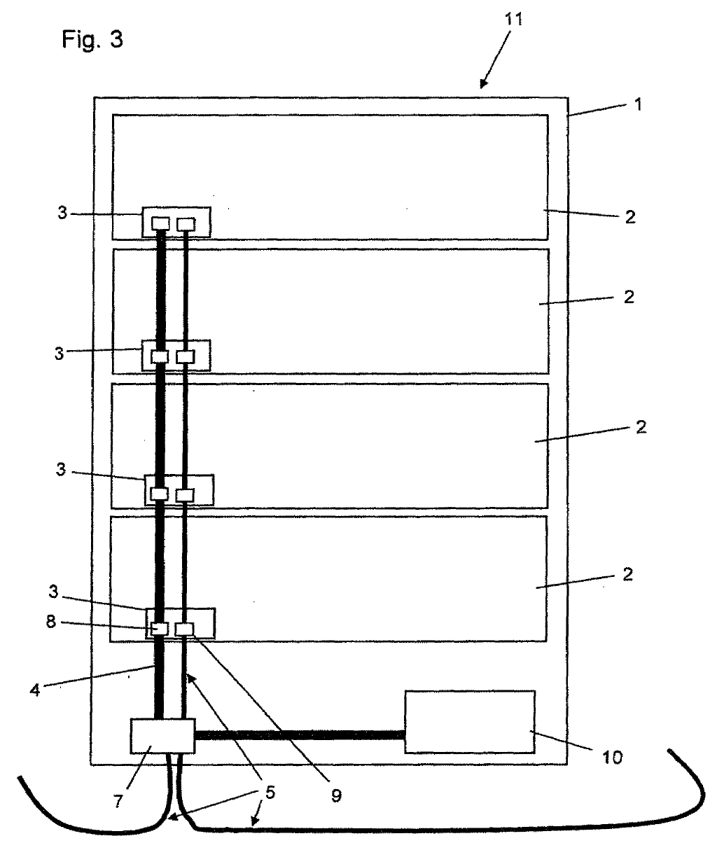

In the embodiment, according to FIG. 3, the control unit 7, containing the monitoring unit, is not integrated into the power supply 10. To this end, other consumers can be connected to the power bus 4 and the data bus 5. These consumers may also be furniture articles comprising displaceable drawers. Of course, a wide variety of other consumers of a consumer chain, for example in a kitchen, can also be connected thereto. In this case the individual elements, such as the furniture article 11, which is depicted in FIG. 3 and which has a body 1 and drawers 2, which can be mounted in a displaceable manner in said body, can be designed with a separate power supply 10. Of course, it is also conceivable that all of the attached elements are supplied with electric power over a single power supply 10.

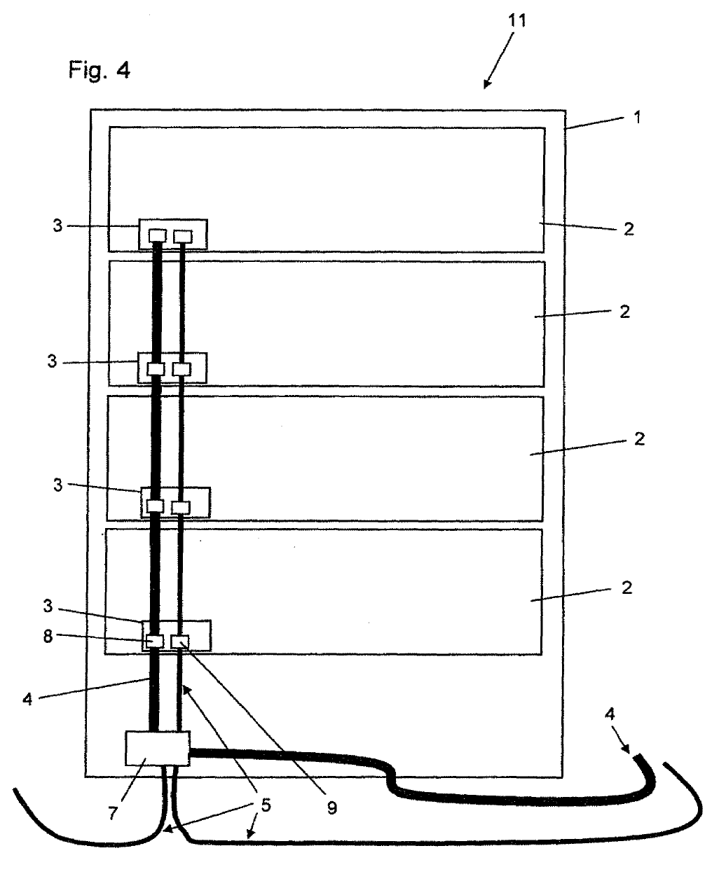

In contrast to the above described embodiments, the embodiment, depicted in FIG. 4, does not exhibit an internal power supply 10, but rather an external power supply (not illustrated). This external power supply is connected to the consumers 3 over a power bus 4 with the control unit 7, and the power bus 4 is connected over the plug and socket connectors 8 to the individual consumers.

The operating principle of the embodiments, depicted in FIGS. 3 and 4, matches that of the embodiment, described in FIG. 1.

For all of the above described embodiments it is, of course, possible to provide the attached consumers, such as the drives 3, with a separate control unit. In this case the central control unit 7 can be operated as the master unit, and the control units of the consumers can be operated as the slave unit of a master/slave configuration. In this case the central control unit 7 assumes in essence the actuation of the individual consumers, whereas the control units of the individual consumers 3 control and monitor their function.

In this case it can also be provided that in the event that the central control unit 7 fails, the slave units of the consumers 3 also take over its tasks, so that a redundancy is created in the system.

Furthermore, the drawers 2, depicted in the figures, may exhibit additional consumers, for example lighting means, and/or be mounted thereon. These additional consumers can also be connected advantageously to the power bus 4 and the data bus 5 by means of a plug and socket connector.

While preferred embodiments of the invention have been described and illustrated here, various changes, substitutions and modifications to the described embodiments will become apparent to those of ordinary skill in the art without thereby departing from the scope and spirit of the invention.

### LIST OF REFERENCE NUMERALS

1 body
2 drawer
3 drive, including control unit
4 power bus
5 data bus
6 common plug and socket connector
7 control unit
8 plug and socket connector power bus
9 plug and socket connector data bus
10 power supply
11 furniture article

1-21. (canceled)

22. In an energy supply device (10) for a plurality of energy consumers (3) that are connected to said energy supply device, wherein the energy supply device exhibits a predetermined maximum power outputs wherein the improvement comprises:
a monitoring device provided for the output power and which prevents the energy supply device (10) from exceeding the predetermined maximum output power and wherein the energy supply device (10) is designed for the purpose of subsequently attaching additional consumers.

23. The energy supply device as claimed in claim 1, wherein the energy supply device is an electric power supply device (10).

24. The energy supply device as claimed in claim 1, wherein the monitoring device is designed to stop the switching on of an additional energy consumer, if by switching on, the predetermined maximum power output would be exceeded.

25. The energy supply device as claimed in claim 1, wherein the energy consumers (3), which are to be connected to the energy supply device (10), are assigned a priority, so that the monitoring device is designed for switching off at least one energy consumer having a low priority, if by switching on an additional energy consumer, the predetermined maximum power output would be exceeded.

26. The energy supply device as claimed in claim 25, wherein upon switching off the additional energy consumer, the monitoring device is designed for switching on the at least one energy consumer having a low priority that previously was switched off.

27. The energy supply device as claimed in claim 1, wherein the monitoring device for checking and controlling the power output to the attached consumers (3) comprises a microcontroller control unit (7).

28. The energy supply device as claimed in claim 27, wherein the microcontroller control unit (7) is connected to all of the attached consumers (3) by way of a data bus (5).

29. The energy supply device as claimed in claim 27, wherein the microcontroller control unit (7) is designed as a master unit, and the attached consumers (3) are designed as the slave unit of a master/slave configuration.

30. The energy supply device as claimed in claim 1, wherein the monitoring device is designed for switching off all of the attached consumers (3), when an overload of the energy supply device (10) such as a consequence of a short circuit is detected.

31. The energy supply device as claimed in claim 1, wherein the monitoring device is provided with an activatable and deactivatable energy saving device, by means of which the attached consumers (3) are put into a state of minimum energy consumption.

32. The energy supply device as claimed in claim 31, wherein the monitoring device is provided with a time limit switch, by means of which an energy saving device can be activated and deactivated.

33. The energy supply device as claimed in claim 1, wherein the monitoring device is provided with a temperature measuring device, by means of which the energy output to the attached consumers (3) is throttled or rather switched off upon exceeding an internal threshold temperature.

34. The energy supply device as claimed in claim 1, further comprising an interface with a CHAIN bus for attaching the energy supply device to an already existing network such as a home appliance network.

35. A bus system, comprising:
at least one power bus (4) for connecting a plurality of energy consumers (3) to an energy supply device (10); and
at least one data bus (5), which is used to communicate between a control unit (7) and the plurality of energy consumers (3) that are attached, in order to check and to control power output of the energy supply device (10) to the energy consumers (3).

36. The bus system, as claimed in claim 35, further comprising an interface with a CHAIN bus for attaching the bus system to an already existing network such as a home appliance network.

37. A furniture article comprising at least one energy supply device as claimed in claim 1.

38. A furniture article comprising at least one bus system as claimed in claim 35.

39. A building system comprising at least one energy supply device as claimed in claim 1.

40. A building system comprising at least one bus system as claimed in claim 35.

41. A building comprising at least one energy supply device as claimed in claim 1.

42. A building comprising at least one bus system as claimed in claim 35.

43. A building comprising at least one building system as claimed in claim 39.

44. A method of monitoring and controlling energy output of an energy supply device (10) so as to prevent exceeding a predetermined maximum power output, comprising:
providing a monitoring device that prevents the energy supply device (10) from exceeding the predetermined maximum output power and wherein the energy supply device (10) is designed for the purpose of subsequently attaching additional consumers, wherein the energy consumers (3), which are to be connected to the energy supply device (10), are assigned a priority, so that the monitoring device is designed for switching off at least one energy consumer having a low priority, if by switching on an additional energy consumer, the predetermined maximum power output would be exceeded.
